(19) United States
(12) Patent Application Publication
(10) Pub. No.: US 2014/0359668 A1
(43) Pub. Date: Dec. 4, 2014

(54) METHOD, ELECTRONIC DEVICE, AND COMPUTER PROGRAM PRODUCT

(71) Applicants: Kabushiki Kaisha Toshiba, Tokyo (JP); Toshiba Lifestyle Products & Services Corporation, Tokyo (JP)

(72) Inventor: Kentaro Nagahama, Tachikawa (JP)

(21) Appl. No.: 14/462,311

(22) Filed: Aug. 18, 2014

Related U.S. Application Data
(63) Continuation of application No. PCT/JP2013/064934, filed on May 29, 2013.

(51) Int. Cl. H04N 21/262; H04N 21/854; H04N 21/84; H04N 21/482

(52) U.S. Cl. CPC H04N 21/26283; H04N 21/4821; H04N 21/854; H04N 21/84
USPC 725/40

(57) ABSTRACT

According to one embodiment, method includes: acquiring information on programs corresponding to channels scheduled to be broadcasted for time slots, the time slots including first time slot, second time slot after the first time slot, and third time slot after the second time slot; selecting, for the time slots, at least one of programs in accordance with condition of program selection, wherein first program is selected for the first time slot, no program is selected for the second time slot, and second program is selected for the third time slot; and outputting information for displaying a program table comprising a field displaying information of the first program, a field displaying information regarding a viewable program according to a time length of the second period, and a field displaying information of the second program, wherein the viewable program is selected from programs recorded in a storage or receivable from a server.

### CROSS-REFERENCE TO RELATED APPLICATIONS

This application is a continuation of international application No. PCT/JP2013/064934, filed May 29, 2013, which designates the United States, incorporated herein by reference.

### FIELD

Embodiments described herein relate generally to a method, an electronic device, and a program.

### BACKGROUND

Conventionally, there has been known a technology to display a program table on a television receiver and a portable terminal.

In this type of technologies, it is helpful if a program table that is more convenient for users can be acquired, as one example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary explanatory diagram illustrating a schematic configuration of one example of a system according to an embodiment;

FIG. 2 is an exemplary block diagram illustrating one example of an electronic device in embodiment;

FIG. 3 is an exemplary block diagram illustrating one example of an electronic device in the embodiment;

FIG. 4 is an exemplary flowchart illustrating one example of a process in a method in the embodiment;

FIG. 5 is an exemplary diagram illustrating one example of a program table displayed on the electronic device by the method in the embodiment;

FIG. 6 is an exemplary diagram illustrating another example of the program table displayed on the electronic device by the method in the embodiment;

FIG. 7 is an exemplary diagram illustrating yet another example of the program table displayed on the electronic device by the method in the embodiment;

FIG. 8 is an exemplary diagram illustrating another example of the program table displayed on the electronic device by the method in the embodiment;

FIG. 9 is an exemplary diagram illustrating still another example of the program table displayed on the electronic device by the method in the embodiment; and

FIG. 10 is an exemplary diagram illustrating one example of information displayed on a display module, which displays a program, indicating that there is a plurality of programs each having at least a portion broadcasted at the same time in parallel, by the method in the embodiment.

### DETAILED DESCRIPTION

According to one embodiment, a method comprises: acquiring information on a plurality of programs corresponding to a plurality of channels scheduled to be broadcasted for a plurality of time slots, the plurality of time slots including a first time slot, a second time slot after the first time slot, and a third time slot after the second time slot; selecting, for the plurality of time slots, at least one of programs corresponding to one of channels in time slots in accordance with a condition of program selection, wherein a first program is selected from programs to be broadcasted for the first time slot in accordance with the condition, no program is selected from programs to be broadcasted for the second time slot in accordance with the condition, and a second program is selected from programs to be broadcasted for the third time slot in accordance with the condition; and outputting information for displaying on a screen a program table comprising a first field displaying information of the first program, a second field displaying information regarding a viewable program according to a time length of the second period, and a third field displaying information of the second program, wherein the viewable program is selected from programs recorded in a storage or receivable from a server.

The following exemplary embodiments and modifications comprise the same or similar constituent elements. Such same or similar constituent elements are given with common reference numerals or signs, and the redundant explanations thereof are omitted. The embodiments and modifications comprising the same or similar constituent elements can yield the same or similar results (effects) based on the same or similar constituent elements. Furthermore, the ordinal numbers such as first and second in the present specification are given for the sake of conveniently differentiating the constituent elements and the like, and are not intended to mean the order of processing, priority, importance, and the like.

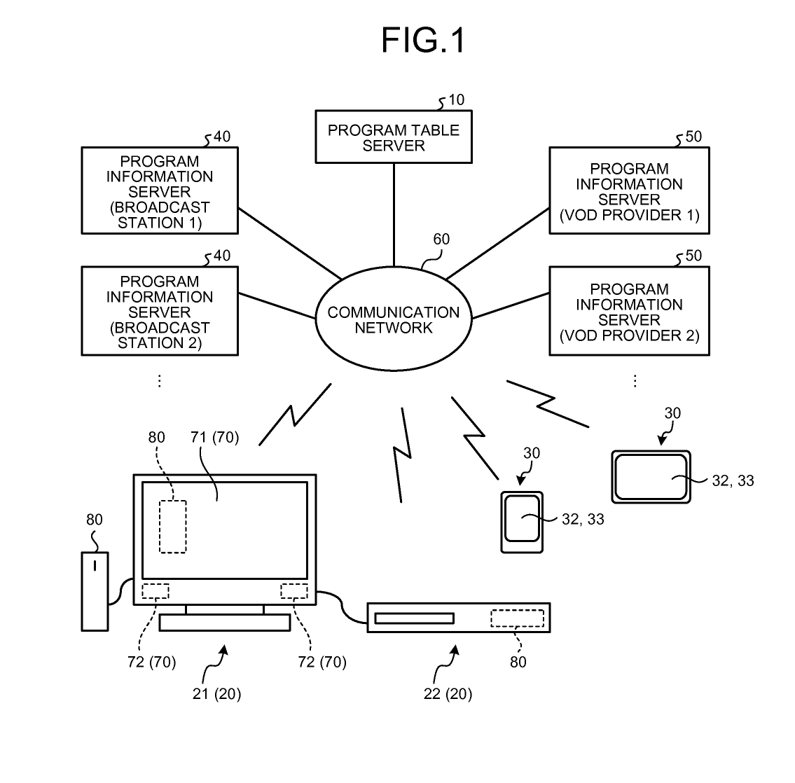

In a present embodiment, as illustrated in FIG. 1, a system comprises, for example, a program table server 10 (a server, an electronic device, or an apparatus), electronic devices 20 and 30 (devices or display devices), and program information servers 40 and 50 (servers, electronic devices, or apparatuses). The program table server 10, the electronic devices 20 and 30, and the program information servers 40 and 50 are connected so as to be able to communicate with one another via, for example, a wired or wireless communication network 60 (a telecommunication line). The communication network 60 comprises, for example, devices such as a router, a base station apparatus, and an access point, and cables (not depicted). The program table server 10, the electronic devices 20 and 30, and the program information servers 40 and 50 can perform transfer (communication) of various data (information) with one another in accordance with a predetermined communication protocol via the communication network 60.

The program table server 10 transmits the data to be a source of program table (an electronic program guide) to the electronic devices 20 and 30 via the communication network 60. The data to be a source of program table is the data of information to display the program table (program table information) on a display output device 71 and on a display module 33. The data to be a source of program table comprises the data of, for example, information on broadcast channels (channel information) and information on programs (program information).

The program information servers 40 and 50 transmit the data of program information to the program table server 10 via the communication network 60. The program information server 40 is a server, for example, provided in each broadcast station (broadcast station 1, broadcast station 2, and so on) or related to each broadcast station. The program information server 50 is a server, for example, provided in each video-on-demand (VOD) provider (VOD provider 1, VOD provider 2, and so on) or related to each VOD provider. The program information server 40 transmits the data of program information on broadcasts to the program table server 10. The program information server 50 transmits the data of program information on VOD (content information) to the program table server 10. Furthermore, the program table server 10 can acquire the data of the information related to programs (program related information, meta information, or attribute information, e.g., information indicative of the popularity of program, the number of views, the number of recordings, the number of requests, and the rankings of the foregoing) from the electronic devices 20 and 30 corresponding to the electronic devices 20 and 30 that are provided with the data to be a source of program table (program table information) and display the program table. More specifically, for example, in a storage module (not depicted) of each of the electronic devices 20 and 30, a log (history information) such as the number of views, the number of recordings, and the number of requests is stored for each program or being associated with a genre of the program. Moreover, for example, the storage modules of the respective electronic devices 20 and 30 on which the program table is displayed store therein (register or set up) identification data (for example, IP addresses) of the electronic devices 20 and 30 corresponding to the electronic devices 20 and 30. The program table server 10 can acquire logs from the electronic devices 20 and 30 corresponding to the identification data, and based on the logs, can acquire or generate the information related to the programs corresponding to the electronic devices 20 and 30. The identification data of the electronic devices 20 and 30 to be the target of acquiring logs can be stored (registered or set up) being associated with an ID and an account of a program table application. Furthermore, the identification data can be stored in the storage modules (not depicted) of the electronic devices 20 and 30, the program table server 10, and other devices. The program table server 10 can further acquire the data of the information related to programs (program related information, meta information, or attribute information, e.g., information indicating the popularity of program, the number of viewing devices, audience rating, the number of views, the number of requests, and the rankings of the foregoing) from the program information servers 40 and 50.

The electronic device 20 can receive broadcast waves comprising (carrying) data such as a program (content). The electronic device 20 can further control an output device 70, and send video data (image data) and audio data to the output device 70. The output device 70 can output the video and audio of the program. The electronic device 20 is, for example, a television receiver 21, a recorder 22, a home terminal (not depicted), and a personal computer (not depicted). The output device 70 is the display output device 71 (a display module or a second display module, e.g., a display panel), audio output devices 72 (audio output modules, e.g., speakers), and the like. The output device 70 may be integrally combined with the electronic device 20 or may be a separate device from the electronic device 20. The display output device 71, for example, is a liquid crystal display (LCD) and an organic electroluminescent display (GELD).

Furthermore, the electronic device 20 has a function of recording programs. The electronic device 20 can store program (content) data (video data, audio data, and the like) in a storage module 80 in response to timer recording (information on timer recording or information indicating programming of video recording). Moreover, the data of the information relating to the recordings of the electronic device 20 (recording information) is stored in the storage module 80. The recording information is the information on recorded programs, identification information of the electronic device 20, the information indicative of whether the storage module 80 is recordable, and the like. The information on recorded program is, for example, identification (ID) of program, channel of program, and the date and time of broadcast. The information indicating whether it is recordable is, for example, an available recording time and a flag (not recordable=0 or recordable=1). The storage module 80 is a nonvolatile storage module, and is a hard disk drive (HDD) and a solid state drive (SSD), as one example. The storage module 80 may be comprised in the electronic device 20 or may be a device separate from the electronic device 20. The data of the information relating to the recordings and the program (content) data (data corresponding to the content) may be stored in storage modules different from each other.

The electronic device 20 can further transmit, in response to a request from other devices (as one example, the program table server 10), the recording information (the data thereof) to the other devices.

The electronic device 30 receives the data to be a source of program table via the communication network 60. The electronic device 30 can control the display module 33 to display the program table, and can send the data of the program table (data for display) to the display module 33. The display module 33 can display the program table. The electronic device 30 is, for example, a personal computer (for example, a tablet computer), a smartphone, a cellular phone, a personal digital assistant (PDA), and a game machine. In FIG. 1, the electronic devices 30 are illustrated as tablet computers. The electronic device 30 is one example of a portable terminal, a communication device, and a remote device.

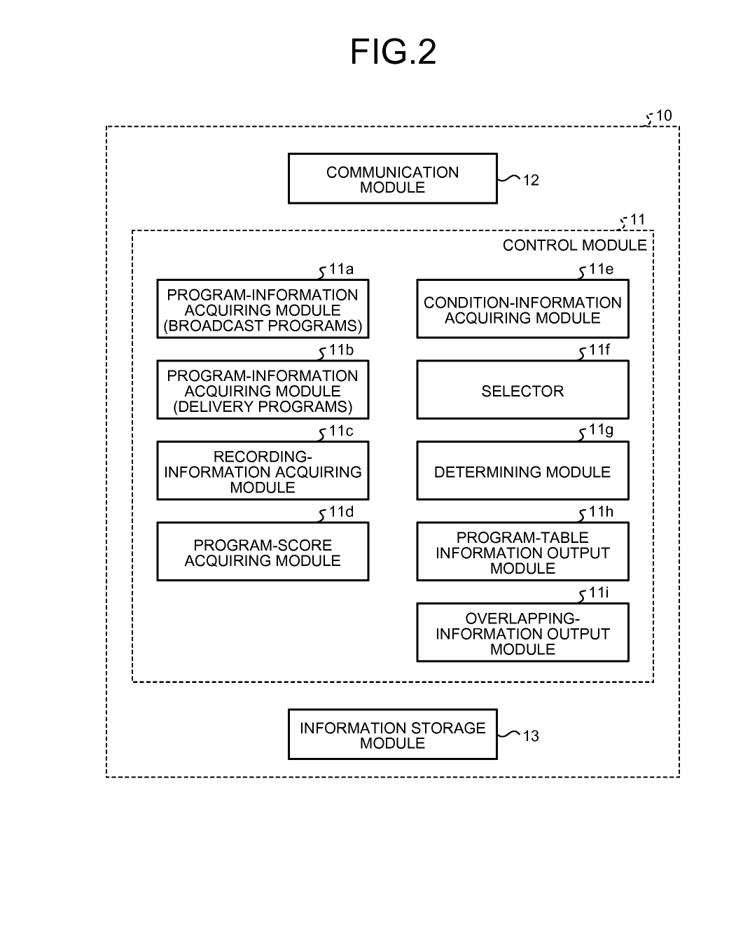

The program table server 10 is configured as a computer and comprises a central processing unit (CPU), a controller, a storage module, an input module, an output module, and a communication module 12. The storage module comprises, for example, a random access memory (RAM), a read only memory (ROM), an HDD, and an SSD. The storage module comprises an information storage module 13. The information storage module 13 stores therein data such as program information, recording information, program score information, condition information, and program table information. The program score information is one type of program related information, and is the information (numerical values) in which, for example, the popularity and importance of program are digitized in accordance with a predetermined rule. The value (numerical value) of the program score information is, for example, higher as the popularity and importance of program are higher. The condition information is the information of criteria for program selection. Specifically, the information indicating the condition of program information is, for example, the information indicating the attribution of program, the information indicating a genre of program (e.g., news, sport, and drama), the information indicating a range of values of the program score information, the information indicating time (e.g., the start time for setting a virtual channel), the information indicating time slot, and the information indicating the number of programs. The start time for setting a virtual channel may be set up in advance or may be the time an application for a program table PT is started up on the electronic device 30. The information storage module 13 is a nonvolatile storage module, and is an HDD and an SSD, for example. The input module (not depicted) is, for example, a touch panel and a keyboard. The output module (not depicted) is, for example, a display module and a speaker. The CPU can execute various arithmetic processes in accordance with programs loaded (for example, an operating system (OS), applications, and web applications). In the embodiment, by the processes of the CPU and the like performed in accordance with the programs, a control module 11 illustrated in FIG. 2 (a program-information acquiring module 11a, a program-information acquiring module 11b, a recording-information acquiring module 11c, a program-score acquiring module 11d, a condition-information acquiring module 11e, a selector 11f, a determining module 11g, a program-table information output module 11h, an overlapping-information output module 11i, and the like) functions, as one example.

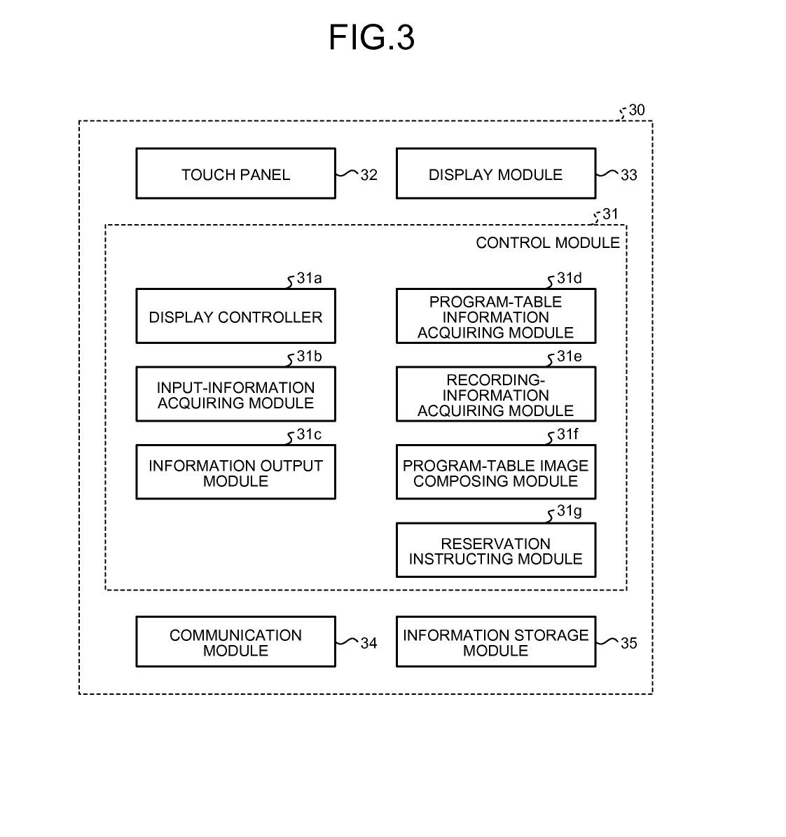

The electronic device 30 is configured as a computer and comprises a CPU, a controller, a storage module, an input module, an output module, and a communication module 34. The storage module is, for example, a RAM, a ROM, an HDD, and an SSD. The storage module comprises an information storage module 35. The information storage module 35 stores therein data such as condition information (setting information), recording information, and program table information. The information storage module 35 is a nonvolatile storage module, and is an HDD and an SSD, for example. The input module is, for example, a touch panel 32 and a keyboard (not depicted). The output module is, for example, the display module 33 and a speaker (not depicted). The display module 33 (a first display module, e.g., a display panel) is, for example, an LCD and an GELD. The CPU can execute various arithmetic processes in accordance with programs loaded (for example, an operating system (OS), applications, and web applications). In the embodiment, by the processes of the CPU and the like performed in accordance with the programs, a control module 31 illustrated in FIG. 3 (a display controller 31a, an input-information acquiring module 31b, an information output module 31c, a program-table information acquiring module 31d, a recording-information acquiring module 31e, a program-table image composing module 31f, and a reservation instructing module 31g) functions, as one example.

Although not depicted, the electronic device 20 is also configured as a computer and comprises a CPU, a controller, a storage module, an input module, an output module, and a communication module. The storage module comprises, for example, a RAM, a ROM, an HDD, and an SSD. The electronic device 20 can have the same configuration as all or a part of the configuration of the electronic device 30 illustrated in FIG. 3 (the display controller 31a, the input-information acquiring module 31b, the information output module 31c, the program-table information acquiring module 31d, the recording-information acquiring module 31e, the program-table image composing module 31f, and the reservation instructing module 31g), and can have the functions corresponding thereto.

The respective programs for the program table server 10, the electronic device 20, and the electronic device 30 can be provided in a file of an installable format or an executable format recorded on a computer readable recording medium such as a compact disc ROM (CD-ROM), a flexible disk (FD), a CD recordable (CD-R), and a digital versatile disk (DVD). Furthermore, the program can be introduced by storing it in a storage module of a computer connected to a communication network and by downloading it via the network. The program may be embedded in a ROM or the like in advance.

In the program table server 10, the program-information acquiring module 11a, for example, acquires the data of program information on programs scheduled to be broadcasted (broadcast programs) from the program information server 40. The program information comprises, for example, program ID, program title, program number, broadcasting date and time of program, description of program, channel number, channel name, channel logo, and the name of broadcast station. The data of the program information and such acquired is stored in the information storage module 13. The program-information acquiring module 11a is one example of an acquiring module. The data of the program information on broadcast programs can be acquired through a mediation device (the device of a mediation agent) and the like.

The program-information acquiring module 11b, for example, acquires the data of program information on programs delivered (delivery programs) from the program information server 50 via the communication network 60. The program information comprises, for example, program ID, program title, program number, description of program, and the name of VOD provider. The data of the program information and such acquired is stored in the information storage module 13. The program-information acquiring module 11b is also one example of an acquiring module. The data of program information on delivery programs can also be acquired through a mediation device (the device of a mediation agent) and the like.

The recording-information acquiring module 11c, for example, acquires the data of recording information from the electronic device 20. The acquired data of recording information is stored in the information storage module 13 associated with the data of identification information of the electronic device 20. The program-score acquiring module 11d, for example, acquires the data of program score information from the program information servers 40 and 50. The condition-information acquiring module 11e, for example, acquires the data of condition information from the electronic device 30.

The selector 11f, for example, compares the program information acquired by the program-information acquiring module 11a and by the program-information acquiring module 11b with the condition information acquired by the condition-information acquiring module 11e to select the programs that match the condition (programs that have the program information matching the condition information) out of a plurality of programs. Specifically, when the condition information, for example, is the information indicating a genre of drama and the information specifying a broadcast time slot, the selector 11f selects the programs of drama to be broadcasted during the broadcast time specified, from among the programs. The condition information can be the information corresponding to the user's preference or the information set up by the user, as one example.

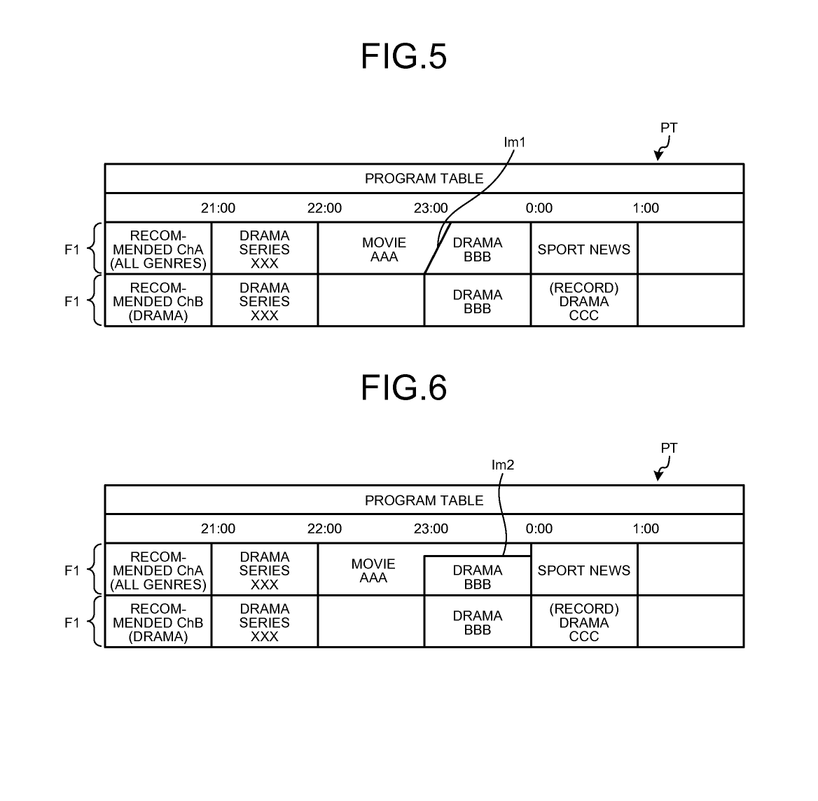

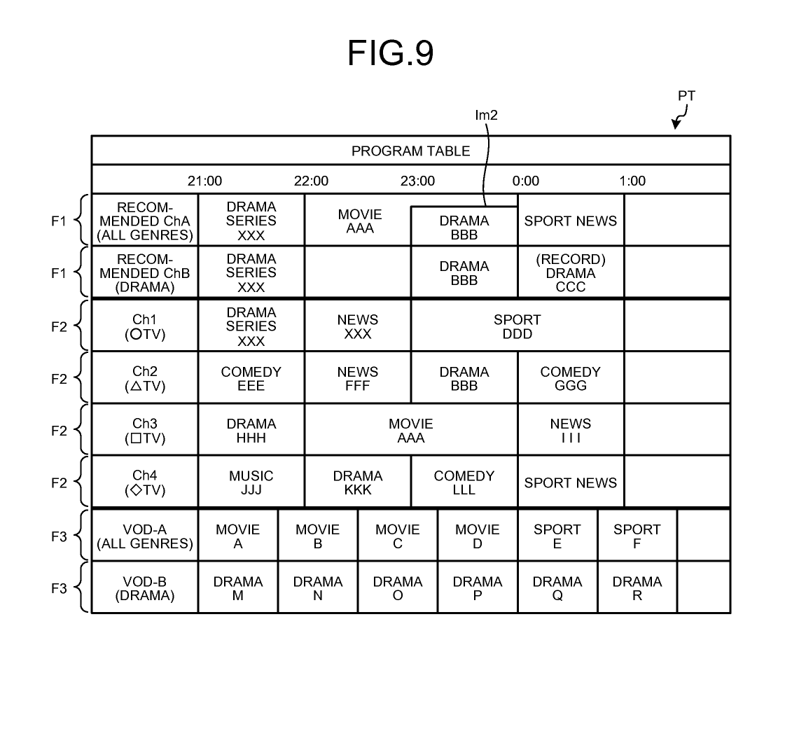

The determining module 11g, for example, determines a timetable of virtual channels. The virtual channel is, in the program table PT (see FIG. 9) displayed on the display module 33 of the electronic device 30 and the display output device 71 of the electronic device 20, an array of programs constituting a display field F1 (a first display field) for a virtual channel arranged in parallel with display fields F2 in which programs are arranged in stripes along the time axis (the left-right direction in FIGS. 5 to 9, the time is later on the right side) for each broadcast channel. It can be said that the virtual channel is a list (timetable) of recommended programs with viewing time, which is presented by the program table server 10 as a result of arithmetic processing from among the programs matching the condition specified in advance. On the virtual channel corresponding to the display field F1 containing broadcast programs, the broadcast programs selected by the selector 11f can be arranged on a priority basis in the time slot defined by the condition information, and at the vacant time between the broadcast programs, a delivery program of VOD, a recorded program, and the like can be arranged. Furthermore, on the virtual channel corresponding to VOD, the delivery programs selected by the selector 11f can be arranged based on the score information and the like (for example, in the order of higher scores) in the time slot defined by the condition information. The time to arrange the delivery programs and the recorded programs can be defined according to the genres thereof.

In the embodiment, the program-table information output module 11h outputs the program table information (information to be a source of program table or information to display the program table) that comprises at least the timetable of the virtual channels (the program information to display the display fields F1 for the virtual channels), as one example. The data of the program table information output from the program-table information output module 11h is transmitted to the electronic device 20, the electronic device 30, and the like. The program-table information output module 11h is one example of an output module (a first output module).

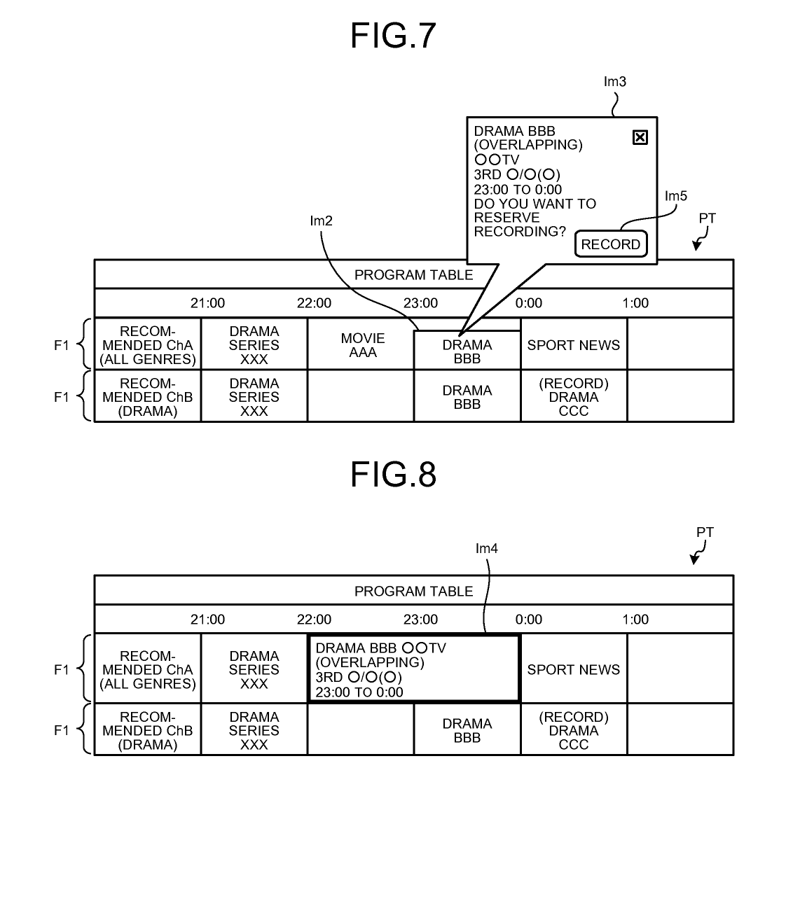

In the embodiment, when there are a plurality of programs that match the condition and at least a portion of each of the programs is to be broadcasted in parallel (in an overlapping manner), the selector 11f and the determining module 11g can select those programs to comprise in the virtual channel, as one example. In this case, as illustrated in FIGS. 5 to 9, the display field F1 of the program table PT comprises display elements Im1 to Im4 indicating that there are a plurality of programs each comprising at least a portion that is broadcasted in parallel. Furthermore, in the embodiment, the program table server 10 (for example, the determining module 11g thereof) can determine the display form (for example, the display elements Im1 to Im4) that corresponds to the programs being overlapped, as one example. In this case, the determining module 11g can configure images and information that are added to the program table PT by the input operation performed on the electronic device 30 or that change on the program table PT by the input operation performed on the electronic device 30. The data of the display elements Im1 to Im4 corresponding to the programs being overlapped, and the display elements Im3 and Im4 that are added to the program table PT or change on the program table PT (images, display areas, see FIGS. 7, 8, and the like) are then transmitted to the electronic device 20, the electronic device 30 and the like, together with the data of program table information or separately from the data of program information by the operation of, for example, the program-table information output module 11h and the communication module 12. Moreover, in the embodiment, the program-table image composing module 31f of the electronic device 30 (see, FIG. 3) can compose the display form (for example, the display elements Im1 to Im4) that corresponds to the programs being overlapped, as another example. In this case, the program-table image composing module 31f composes an image of the program table PT that comprises the display form corresponding to the programs being overlapped when the time information of the programs comprised in one virtual channel overlaps.

In the embodiment, when configuring a virtual channel for delivery programs (the virtual channels corresponding to display fields F3 in FIG. 9), the selector 11f and the determining module 11g can cause the virtual channel of the delivery programs (the display fields F3) to comprise a plurality of delivery programs that match the condition at a shorter time interval than the time length of each delivery program, as one example. Furthermore, the selector 11f and the determining module 11g can cause the virtual channel of the delivery programs (the display fields F3) to comprise the delivery programs at a fixed time interval.

Moreover, in the embodiment, the overlapping-information output module 11i can output the information (the data thereof) indicating that there are a plurality of programs each comprising at least a portion that is broadcasted in parallel on the virtual channel for broadcast programs, as one example. The overlapping-information output module 11i is one example of an output module (a second output module).

In the electronic device 30, the display controller 31a, for example, sends the data to display the program table PT (see FIGS. 5 to 9) and the like to the display module 33.

The input-information acquiring module 31b acquires the information in response to the operation performed on the input module (for example, the touch panel 32) by the user.

The information output module 31c outputs the data of the information acquired by the input-information acquiring module 31b. The communication module 34 transmits the data of the information output by the information output module 31c and by the reservation instructing module 31g to the program table server 10, the electronic device 20, and the like.

The program-table information acquiring module 31d acquires the program table information (the data thereof) transmitted from the program table server 10. The recording-information acquiring module 31e acquires the recording information (the data thereof) transmitted from the electronic device 20.

The program-table image composing module 31f composes an image of a program table from the program table information acquired by the program-table information acquiring module 31d, the display form corresponding to the programs being overlapped, and the recording information acquired by the recording-information acquiring module 31e. In this case, the size of the program table PT and the display form are appropriately adjusted in response to the number of display fields F1 to F3 displayed on the program table PT and the length of time slot. The program-table image composing module 31f can also compose the display element Im3 (an image, see FIG. 7) that is added (for example, appears), the display element Im4 (an image, see FIG. 8) that changes (for example, expands), and the like, in response to the input operation of the user when the input operation is acquired by the input-information acquiring module 31b.

The reservation instructing module 31g outputs the information (the data thereof) that instructs the electronic device 20 to schedule timer recording and timer viewing based on the information acquired by the input-information acquiring module 31b and by the program-table information acquiring module 31d. The information instructing the timer recording and timer viewing comprises, for example, the identification information of the electronic device 20, the identification information of the electronic device 30, and the identification information of the program.

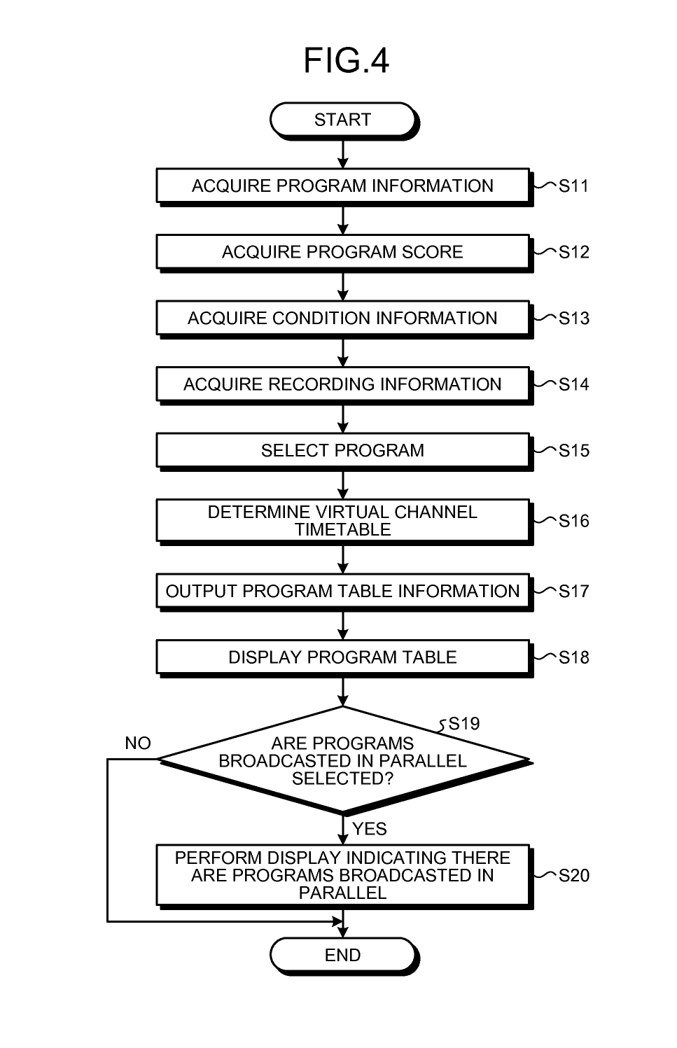

Now, with reference to FIG. 4, one example of a process to display a program table will be described. The processing procedure in FIG. 4 can be started at the time the application that displays the program table is started up on the electronic device 30, as one example. In this case, the information (the data thereof) that specifies the start-up of the process is transmitted from the electronic device 30 to the program table server 10. The program-information acquiring module 11a and the program-information acquiring module 11b first acquire the data of program information on the programs scheduled to be broadcasted (broadcast programs) and the programs delivered via the communication network 60 (delivery programs) (S11).

Next, the program-score acquiring module 11d acquires the data of program score information (S12), the condition-information acquiring module 11e acquires the data of condition information (S13), and the recording-information acquiring module 11c acquires the data of recording information (S14).

The selector 11f then selects the programs that match the condition of program selection (programs that have the program information matching the condition information) from among a plurality of programs for which the program information is acquired (S15). The determining module 11g then determines a timetable of virtual channels (S16). The program-table information output module 11h then outputs the program table information that comprises at least the timetable of virtual channels (S17). The data of the program table information output from the program-table information output module 11h is transmitted to the electronic device 20, the electronic device 30, and the like. Then, the program table PT (see FIGS. 5 to 9) is displayed on the display module 33 of the electronic device 30 and on the display output device 71 of the electronic device (S18).

Furthermore, if a plurality of programs each having at least a portion that is broadcasted in parallel are selected at S15 (Yes at S19), in the program table PT displayed on the display module 33 of the electronic device 30 and on the display output device 71 of the electronic device 20, a display indicating that there are programs each having at least a portion that is broadcasted in parallel is displayed (S20). When displaying the display at S20, the information (the data thereof) that specifies the display is transmitted from the program table server 10 to the electronic device 30 and to the electronic device 20. This information comprises the information specifying the timing (time) to perform the display. The control module 31 of the electronic device 30 and that of the electronic device 20 store the information specifying the display in the respective information storage modules 35, and at the time the designated time is reached, perform the display of the specified content. In contrast, if it is No at S19, the display indicating that there are programs each having at least a portion that is broadcasted in parallel is not performed.

Next, with reference to FIGS. 5 to 9, display examples of the program table PT will be described. The program table PT illustrated in FIG. 5 comprises only the display fields F1 for virtual channels. The upper display field F1 represents the virtual channel that comprises the programs of high program scores. The lower display field F1 represents the virtual channel that comprises the programs of genres specified by the condition information. On the virtual channels, the programs on a plurality of broadcast channels are arranged.

As illustrated in FIG. 5, the display field F1 comprises the display element Im1 (in the embodiment, a diagonal line as one example) indicating that there are a plurality of programs each having at least a portion that is broadcasted in parallel. The display element Im1 enables the user to visually recognize that there are programs each having at least a portion that is broadcasted in parallel. FIG. 6 illustrates the display element Im2 (in the embodiment, a bent line as one example) in a form different from that in FIG. 5.

FIG. 7 illustrates a case in which, when the display element (for example, an area, characters, and the like within a frame of a program) for one side of a plurality of programs each having at least a portion that is broadcasted in parallel is selected by the operation performed by the user on the input module such as the touch panel 32 while the program table PT is displayed, the display element Im3 (an image, e.g., a pop-up image) that indicates the program information on the one side is displayed. When there are a plurality of programs broadcasted in parallel, the display area for the programs in the display field F1 of the program table PT tends to be narrow, and thus the amount of information of the program information that can be presented within the display area is likely to be reduced. In this regard, displaying the display element Im3 is likely to increase the amount of information of the program information. The display element Im3 in FIG. 7 can be displayed based on the process performed by, for example, the input-information acquiring module 31b, the program-table image composing module 31f, and the display controller 31a (see FIG. 3).

Furthermore, in the example in FIG. 7, within the display element Im3, a display element Im5 (an image, in FIG. 7, a button as one example) to perform (receive the instruction of) timer recording is comprised. In this case, when the display element Im5 is selected by the input operation of the user, the timer recording for the broadcast program corresponding to the display element Im5 selected is performed. Consequently, the timer recording can be performed for at least one program out of the programs each having at least a portion that is broadcasted in parallel.

FIG. 8 illustrates a case in which, when the display element (for example, an area, characters, and the like within a frame of a program) for one side of a plurality of programs each having at least a portion that is broadcasted in parallel is selected by an operation performed by the user on the input module such as the touch panel 32 while the program table PT is displayed, the display element Im4 (an image or an area) that indicates the program information on the one side is expanded up to the display area for the program information on the other side. The display element Im4 being expanded is apparent when compared with that in FIG. 6.

FIG. 9 illustrates, together with the display fields F1 for virtual channels, the display fields F2 for broadcast programs and the display fields F3 for delivery programs. This enables the user to know the program information on broadcast programs and the program information on delivery programs that are not comprised in the display fields F1 for virtual channels. Moreover, in the example in FIG. 9, the display fields F3 for delivery programs comprise a plurality of pieces of program information (display elements thereof) at a shorter time interval than the time length of each delivery program and at a fixed time interval. This enables the user to view at one time the program information on more delivery programs that are easier to set up the viewing time more freely. In the display fields F3 for delivery programs, a plurality of pieces of program information may be comprised with the time length of the respective delivery programs. Furthermore, in the display fields F3 for delivery programs, the time slots to display delivery programs can be set up (differentiated) according to the genres of delivery programs. Specifically, the program information on the delivery programs that are not suitable for children to view such as horror movies can be displayed at the time slots in the small hours (at night), and the program information on the delivery programs that are intended for children such as cartoon films can be displayed at the time slots in the morning and in the daytime.

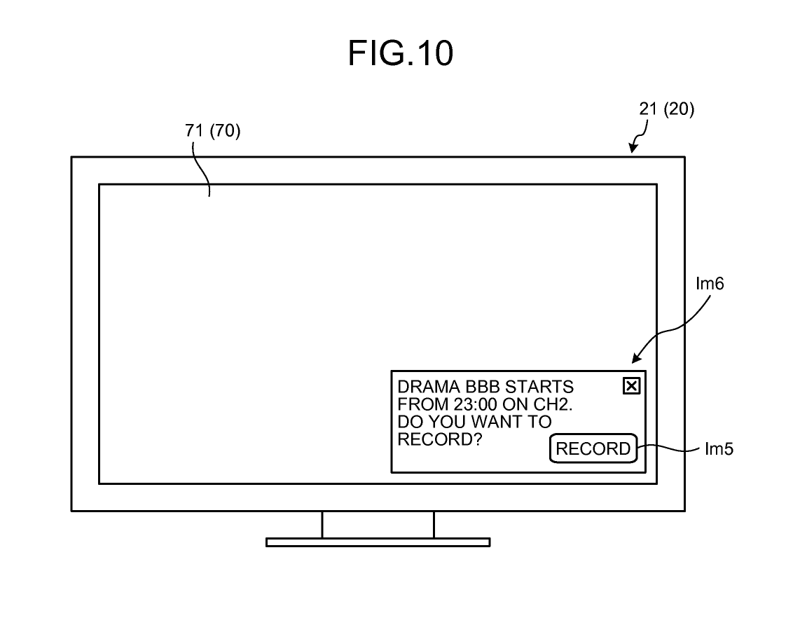

FIG. 10 illustrates a situation in which a display element Im6 (an image), which indicates the information of a plurality of programs each having at least a portion that is broadcasted in parallel being present on the virtual channel of the program table, is displayed on the display output device 71 of the electronic device 20. In the example in FIG. 10, within the display element Im6, further comprised is the display element Im5 (a button or an image) to perform (receive the instruction of) timer recording. In this case, when the display element Im5 is selected by the input operation of the user, the timer recording for the broadcast program corresponding to the selected image is performed. Consequently, the timer recording can be performed for at least one program out of the programs each having at least a portion that is broadcasted in parallel.

As explained in the foregoing, in the embodiment, the display fields F1 (the first display field) for virtual channels, in which the information on at least one broadcast program selected from a plurality of channels in accordance with the condition of selection is arranged according to the airtime, is displayed on the display module 33 (the first display module), as one example. Consequently, in accordance with the embodiment, the programs that match the popularity and importance of program or the user's preference, for example, are collectively displayed in the display fields F1 for virtual channels defined in the program table PT. More specifically, in accordance with the embodiment, the program table PT that is more convenient for the user can be provided, as one example.

Furthermore, in the embodiment, the display fields F1 for virtual channels comprise the display elements Im1 to Im4 indicating that there are a plurality of programs each having at least a portion that is broadcasted at the same time in parallel, as one example. Consequently, in accordance with the embodiment, the user is easy to recognize that there are programs each having at least a portion that is broadcasted at the same time in parallel, as one example. Moreover, this increases a choice of programs to view for the user.

In the embodiment, there are a plurality of programs each having at least a portion that is broadcasted at the same time in parallel is displayed on the display output device 71 (the second display module) that displays a program, as one example. Consequently, in accordance with the embodiment, the user is easier to recognize that there are programs each having at least a portion that is broadcasted at the same time in parallel, as one example. This further increases a choice of programs to view for the user.

In the embodiment, the program table PT comprises the display fields F3 (the second display field) in which the information on delivery programs are arranged in a shorter interval than the time length of each program, as one example. Consequently, in accordance with the embodiment, for the delivery programs that are easier to set up the viewing time more freely, the user is able to view the program information on more delivery programs at one time, as one example.

While the embodiment and the modification of the present invention have been exemplified in the foregoing, these embodiment and modification have been presented by way of example only, and are not intended to limit the scope of the invention. These embodiment and modification described herein can be embodied in a variety of other forms, and various omissions, substitutions, combinations, and changes to these embodiment and modification can be made without departing from the spirit of the invention. Such embodiment and modification would fall within the scope and spirit of the invention, and are intended to be covered by the accompanying claims and their equivalents. The invention can further yield various effects provided by the basic results (effects) achieved by the constituent elements (steps). The effects in the foregoing are mere examples. Furthermore, the specifications of the various constituent elements can be implemented with appropriate changes. For example, the electronic device 30 and the electronic device 20 in the above-described embodiment can serve as an electronic device in place of the program table server 10. Moreover, the display elements in various forms (lines, frames, areas, images, marks, patterns, designs, characters, icons, and the like) can be used.

The various modules of the systems described herein can be implemented as software applications, hardware and/or software modules, or components on one or more computers, such as servers. While the various modules are illustrated separately, they may share some or all of the same underlying logic or code.

What is claimed is:

1. A method comprising:
acquiring information on a plurality of programs corresponding to a plurality of channels scheduled to be broadcasted for a plurality of time slots, the plurality of time slots including a first time slot, a second time slot after the first time slot, and a third time slot after the second time slot;
selecting, for the plurality of time slots, at least one of programs corresponding to one of channels in time slots in accordance with a condition of program selection, wherein
a first program is selected from programs to be broadcasted for the first time slot in accordance with the condition, no program is selected from programs to be broadcasted for the second time slot in accordance with the condition, and a second program is selected from programs to be broadcasted for the third time slot in accordance with the condition; and
outputting information for displaying on a screen a program table comprising a first field displaying information of the first program, a second field displaying information regarding a viewable program according to a time length of the second period, and a third field displaying information of the second program, wherein
the viewable program is selected from programs recorded in a storage or receivable from a server.

2. The method of claim 1, wherein, if a plurality of the programs each comprising at least a portion broadcasted at the same time in parallel are selected, a single second field comprises a display element indicating that there are a plurality of programs each comprising at least a portion broadcasted at the same time in parallel.

3. The method of claim 1, further comprising outputting, if a plurality of the programs each comprising at least a portion broadcasted at the same time in parallel are selected, information for displaying that there are a plurality of programs each comprising at least a portion broadcasted at the same time in parallel on a second display module configured to display the programs.

4. The method of claim 1, further comprising:
acquiring information on a plurality of programs delivered via a communication network; and
selecting at least one of the programs delivered via the communication network based on information on the programs and information indicating a condition of program selection, wherein
the program table comprises a display field arranged in parallel with the first field, the second field, and the third field, and comprising information on the selected at least one of the programs delivered via the communication network at a shorter time interval than a time length of the selected at least one of the programs.

5. An electronic device comprising:
an acquiring module configured to acquire information on a plurality of programs corresponding to a plurality of channels scheduled to be broadcasted for a plurality of time slots, the plurality of time slots including a first time slot, a second time slot after the first time slot, and a third time slot after the second time slot;
a selector configured to select, for the plurality of time slots, at least one of programs corresponding to one of channels in time slots in accordance with a condition of program selection, wherein
a first program is selected from programs to be broadcasted for the first time slot in accordance with the condition, no program is selected from programs to be broadcasted for the second time slot in accordance with the condition, and a second program is selected from programs to be broadcasted for the third time slot in accordance with the condition; and
an output module configured to output information for displaying on a screen a program table comprising a first field displaying information of the first program, a second field displaying information regarding a viewable program according to a time length of the second period, and a third field displaying information of the second program, wherein
the viewable program is selected from programs in a storage or receivable from a server.

6. The electronic device of claim 5, wherein, if a plurality of the programs each comprising at least a portion broadcasted at the same time in parallel are selected, a single second field comprises a display element indicating that there are a plurality of programs each comprising at least a portion broadcasted at the same time in parallel.

7. The electronic device of claim 5, further comprising a second output module configured to output, if a plurality of the programs each comprising at least a portion broadcasted at the same time in parallel are selected, information for displaying that there are a plurality of programs each comprising at least a portion broadcasted at the same time in parallel on a second display configured to display the programs.

8. A computer program product having a non-transitory computer readable medium including programmed instructions, wherein the instructions, when executed by a computer, cause the computer to perform:
acquiring information on a plurality of programs corresponding to a plurality of channels scheduled to be broadcasted for a plurality of time slots, the plurality of time slots including a first time slot, a second time slot after the first time slot, and a third time slot after the second time slot;
selecting, for the plurality of time slots, at least one of programs corresponding to one of channels in time slots in accordance with a condition of program selection, wherein
a first program is selected from programs to be broadcasted for the first time slot in accordance with the condition, no program is selected from programs to be broadcasted for the second time slot in accordance with the condition, and a second program is selected from programs to be broadcasted for the third time slot in accordance with the condition; and
outputting information for displaying on a screen a program table comprising a first field displaying information of the first program, a second field displaying information regarding a viewable program according to a time length of the second period, and a third field displaying information of the second program, wherein
the viewable program is selected from programs recorded in a storage or receivable from a server.

9. The computer program product of claim 8, wherein, if a plurality of the programs each comprising at least a portion broadcasted at the same time in parallel are selected, a single second field comprises a display element indicating that there are a plurality of programs each comprising at least a portion broadcasted at the same time in parallel.

10. The computer program product of claim 8, further causing the computer to perform outputting, if a plurality of the programs each comprising at least a portion broadcasted at the same time in parallel are selected, information for displaying that there are a plurality of programs each comprising at least a portion broadcasted at the same time in parallel on a second display configured to display the programs.
